(19) United States
(12) Patent Application Publication
(10) Pub. No.: US 2013/0275383 A1
(43) Pub. Date: Oct. 17, 2013

(54) Automatically Converting Emails to Image Files

(71) Applicant: Thomas P. McLarty, Albuquerque, NM (US)

(72) Inventor: Thomas P. McLarty, Albuquerque, NM (US)

(21) Appl. No.: 13/448,171

(22) Filed: Apr. 16, 2012

(51) Int. Cl. G06F 17/30

(52) U.S. Cl. 707/663; 707/670; 707/E17.005

(57) ABSTRACT

In some implementations, a method for archiving emails includes determining an email file presented in an email application through a Graphical User Interface (GUI) has been selected in response to a user moving the email file into a virtual folder in the GUI. The email file is in a first file format native to the email application and has a first presentation format when presented in the email application. In response to moving the email file into the virtual folder, a second file in a second file format native to a second application different from the email application is automatically generated. The second file has, when presented in the second application through the GUI, a second presentation format substantially similar to the first presentation format. Data in the email file is stored in the second file.

### TECHNICAL FIELD

This invention relates to file conversion and, more particularly, to automatically converting files between different formats.

### BACKGROUND

In many instances, regulatory requirements insist businesses, federal state and municipal governments, hospitals, banks, firms, schools and many other entities in the U.S. and worldwide archive files such as emails. For example, oversight agencies may require that business emails, including attachments and metadata, be archived in a separate environment and/or in a different format.

### SUMMARY

In some implementations, a method for archiving emails includes determining an email file presented in an email application through a Graphical User Interface (GUI) has been selected in response to a user moving the email file into a virtual folder in the GUI. The email file is in a first file format native to the email application and has a first presentation format when presented in the email application. In response to moving the email file into the virtual folder, a second file in a second file format native to a second application different from the email application is automatically generated. The second file has, when presented in the second application through the GUI, a second presentation format substantially similar to the first presentation format. Data in the email file is stored in the second file.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is an example system environment for automatically converting emails into image files.

FIGS. 2A and 2B are example graphic user interfaces for the example system illustrated in FIG. 1.

FIG. 3 is a flow chart illustrating an example method for automatically converting emails into image files.

Like reference symbols in the various drawings indicate like elements.

### DETAILED DESCRIPTION

This disclosure describes systems, methods, apparatus, and computer-readable media for automatically converting files between different file formats. For example, email files (e.g., MSG files) may be automatically converted to image files (e.g., PDF files) in response to at least an event. An image file may include a Portable Document Format (PDF) file, Tagged Image File Format (TIFF) file, Joint Photographic Experts Group (JPEG) file, or other file configured to present an image through a Graphical User Interface (GUI). In some implementations, an event can include a user selecting an email from an email application and dragging or otherwise moving the email to a virtual folder displayed in a GUI. In some instances, the image file may retain attributes of the original file such a presentation format (e.g., text arrangement), attachments, metadata, or other attributes. For example, the image file may include attachments in the original format as attachments included in the original email file. By executing the conversions, the files (e.g., email files) may be archived in a different, separate environment while substantially maintaining key attributes. Also, the converted files or image files may be a smaller size (e.g., approximately a tenth of the original email size) while maintaining attributes of the original file such as universal resource locator (URL), an attached document, metadata, a presentation format, or other. While the following description is primarily directed at converting emails into images files, other times of files may be converted into archived without departing from the scope of disclosure. For example, a PDF file may be automatically converted to a TIFF file in response to a user moving the PDF file to a virtual folder in a GUI. Thus, when the disclosure describes converting an email file to an image file, the disclosure analogously applies to converting one file in a first format to a second file in a second format.

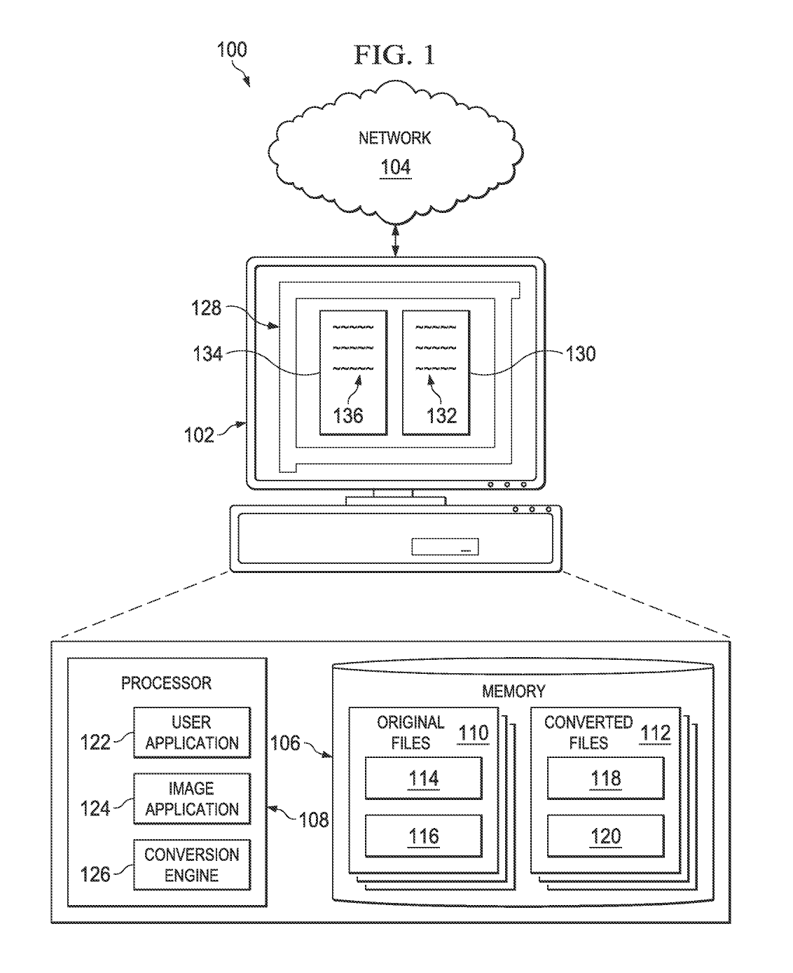

FIG. 1 is an example system environment 100 for automatically converting email files to image files. The illustrated environment 100 includes a user device 102 communicably coupled with a network 104. At least some of the communications between the user device 102 and an external entity (e.g., a server, another user device) may be performed across, via, or otherwise using the network 104. In general, the environment 100 depicts an example configuration of a system for automatically converting emails into image files. As illustrated in FIG. 1, the user device 102 converts the email files to image files. The environment 100 is an example, and in alternative implementations, the elements illustrated in FIG. 1 may be included in or associated with different and/or additional servers, clients, networks, and locations other than those as shown. For example, one or more of the components illustrated within the user device 102 may be located in multiple or different devices (e.g., where conversion can take place), cloud-based networks, or other locations accessible to user device 102 (e.g., either directly or indirectly via the network 104).

At a high level, the user device 102 is an electronic device that are owned, operated or otherwise associated with a user and operable to at least receive access to services from the network 104. The user device 102 includes memory 106 and a processor 108. The memory 106 stores original files 110 and converted files 112. The original file 110 includes a presentation format 114 for defining presentation attributes and an attachment 116. The converted file 112 includes a presentation format 118 for defining presentation attributes and an attachment 120. The processor 108 executes a user application 122, an image application 124, and a conversion engine 126. The user application 122 manages original files 110 including, for example, generating, editing and storing. The image application 124 presents converted files 112 to the user. The conversion engine 126 converts the original files 110 to the converted files 112 in response to at least an event. In addition, the user device 102 includes a Graphical User Interface (GUI) 128 configured to enable a user to interact with, for example, the applications 122 and 124 and the conversion engine 126. As illustrated, the GUI 128 includes a frontend 130 for application 122 that presents file names 132 identifying the original files 110. In addition, the GUI 128 includes a virtual folder 134 that presents file names 136 for the converted files 112. As for a high-level description of operation, the user device 102 may receive the original files 110 from the network 104. The user application 122 may present the original files 110 through the frontend 130 in accordance with the presentation format 114 and including any attachments 116. In response to an event, the conversion engine 126 converts an original file 110 to a converted file 112 including the presentation format 118 and the attachment 120. For example, the conversion engine 126 may identify that a user selected the file name 132 presented through the frontend 130 and moved the original file 110 to the virtual folder 134. The image application 124 may present the converted file 112 through the GUI 128 in accordance with the presentation format 118 and including the attachment 120. As previously mentioned, the presentation format of the converted file 112 may be substantially similar to the presentation format of the original file 110.

Turning to a more detailed description, the user device 102 is any local or remote computing device operable to receive requests from the user via a user interface 116, such as a GUI, a CLI (Command Line Interface), or any of numerous other user interfaces. Thus, where reference is made to a particular interface, it should be understood that any other user interface may be substituted in its place. In various implementations, the user device 102 includes at least GUI 128 and comprises an electronic computing device operable to receive, transmit, process and store any appropriate data associated with system 100. Further, “user device 102” and “user” may be used interchangeably as appropriate without departing from the scope of this disclosure. Moreover, for ease of illustration, the user device 102 is described in terms of being used by one user. But this disclosure contemplates that many users may use one computer or that one user may use multiple computers to submit or review queries via GUI 128. As used in this disclosure, the user device 102 is intended to encompass a personal computer, touch screen terminal, workstation, network computer, kiosk, wireless data port, wireless or wireline phone, personal data assistant (PDA), at least one processor within these or other devices, or any other suitable processing device. For example, the user device 102 may comprise a computer that includes an input device, such as a keypad, touch screen, mouse, or other device that can accept information, and an output device that conveys information associated with the operation of the network 104 or the user device 102, including digital data, visual information, or GUI 128. Both the input device and output device may include fixed or removable storage media such as a magnetic computer disk, CD-ROM, or other suitable media to both receive input from and provide output to users of the user device 102 through the display, namely GUI 128.

The GUI 128 associated with the user device 102 includes a graphical user interface operable to, for example, allow the user to interface with at least a portion of the user application 122, the image application 124, the conversion engine 126 and/or the associated operations and functionality. Generally, the GUI 128 provides the particular user with an efficient and user-friendly presentation of business data provided by or communicated within the system. The GUI 128 may include a plurality of customizable frames or views having interactive fields, pull-down lists, and buttons operated by the user. For example, the GUI 128 may provide interactive elements that allow a user to interact with a particular component within and/or external to the environment 100. For example, the illustrated GUI 128 includes a frontend 130 to the user application 122 enabling the user to interact with the original files 110. In addition, the GUI 128 includes the virtual folder 124 that presents information identifying the converted files 112 stored in memory 106. Different portions of the corresponding component's functionality may be presented and accessible to the user through the GUI 128.

The memory 106 of the user device 102 stores data and program instructions and rules associated with sending and receiving the original files 110 and the converted files 112. The memory 106 may include any memory or database module and may take the form of volatile or non-volatile memory including, without limitation, magnetic media, optical media, random access memory (RAM), read-only memory (ROM), removable media, or any other suitable local or remote memory component. The memory 106 may store various objects, object models, and data, including classes, frameworks, applications, backup data, business objects, jobs, web pages, web page templates, database tables, process contexts, repositories storing services local to the user device 102, and any other appropriate information including any parameters, variables, algorithms, instructions, rules, constraints, or references thereto associated with the user device 102 and its functionality. In some implementations, including a cloud-based system, some or all of the memory 106 may be stored remote from the user device 102, and communicably coupled to the user device 102 for usage. Some or all of the elements may be stored external to the memory 106, for example, over internet storage.

The original files 110 include one or more data structures or entries processible by the user application 122. For example, the original file 110 may be an email file 110 received from the network 104. In the email example, the email file 110 may include one or more of the following: an email address of the sender; a recipient's email address; a time; a date; a subject; correspondence; graphical elements; metadata; attachment; or other information included in the original file 110. Continuing with the email example, the email files 110 can be stored in a format native to Microsoft Outlook, Pegasus Mail, Mozilla's Thunderbird, Apple Inc.'s Mail, or other user application 122. The original file 110 may be stored in one or more tables stored in a relational database described in terms of SQL statements or scripts. In other implementations, the original files 110 may be formatted, stored, or defined as various data structures in text files, Hyperlink Text Markup Language (HTML) files, eXtensible Markup Language (XML) documents, Virtual Storage Access Method (VSAM) files, flat files, Btrieve files, comma-separated-value (CSV) files, internal variables, or one or more libraries. In short, the original files 110 may comprise one table or file or a plurality of tables or files stored on one computer or across a plurality of computers in any appropriate format. Moreover, the original files 110 may be local or remote without departing from the scope of this disclosure and store any type of appropriate data.

In addition, the original file 110 may include a presentation profile 114 that includes any parameters, variables, policies, algorithms, instructions, settings, or rules for defining settings for one or more visual attributes presented through the frontend 130. For example, the presentation profile 114 may define font types, text color, background color, background texture, audio volume and/or pitch, animation colors and/or motion rate, or other settings for a presentation format. In short, the presentation profile 114 defines a presentation format for the original file 110 when presented through the frontend 130. Of course, the above parameters are for example purposes and may not reflect some implementations within the scope of this disclosure. Each of the original files 110 can include one or more attachments 116 such as, for example, a multimedia file (e.g., audio, video, and others), a document file (e.g., presentation, word, spreadsheet), or other file type.

The converted files 112 include one or more data structures or entries processible by the image application 124. For example, the converted file 112 may be the email file 110 converted to a different format such as an image file. In the email example, the converted file 112 may include one or more of the following: an email address of the sender; a recipient email address; a time; a date; a subject; correspondence; graphical elements; metadata; attachment; or other information. In some implementations, the converted files 112 can be in PDF, JPEG, TIFF, GIF, BMP, or other image file formats. The converted files 112 may also be in text formats such as TXT, DOC, DOCX, among others. The converted files 112 may be approximately 1/10 of the file size of the original files 110, depending on the selected image format for the converted files 112 and the parameters related to the image format. For example, JPEG format allows users to define different compression ratio for smaller or larger file sizes. The image resolution of the converted file 160 may also be defined or selected by the user, for example, an email may be converted using 300 dpi for a regular conversion, a 600 dpi for a high definition conversion, a 72 dpi for a low resolution conversion, or other custom conversions. In some instances, the converted files 112 can be recognized using optical character recognition (OCR) methods. The converted files 112 may be stored in one or more tables stored in a relational database described in terms of SQL statements or scripts. In other implementations, the converted files 112 may be formatted, stored, or defined as various data structures in text files, Hyperlink Text Markup Language (HTML) files, eXtensible Markup Language (XML) documents, Virtual Storage Access Method (VSAM) files, flat files, Btrieve files, comma-separated-value (CSV) files, internal variables, or one or more libraries. In short, the converted files 112 may comprise one table or file or a plurality of tables or files stored on one computer or across a plurality of computers in any appropriate format. Moreover, the converted files 112 may be local or remote without departing from the scope of this disclosure and store any type of appropriate data.

As with the original file 112, the converted file 112 may include a presentation profile 118 that includes any parameters, variables, policies, algorithms, instructions, settings, or rules for defining settings for the one or more visual attributes. For example, the presentation profile 118 may define font types, text color, background color, background texture, audio volume and/or pitch, animation colors and/or motion rate, or other settings for a presentation format. In short, the presentation profile 118 defines a presentation format for the converted file 112 when presented by the image application 124. Of course, the above parameters are for example purposes and may not reflect some embodiments within the scope of this disclosure. Each of the converted files 112 can include one or more attachments 120 that such as a multimedia file (e.g., audio, video, and others), a document file (e.g., presentation, word, spreadsheet), or other file type.

The user device 102 also includes processor 108. Although illustrated as a single processor 108 in the user device 102, two or more processors may be used in the user device 102 according to particular needs, desires, or particular embodiments of the system environment 100. The processor 108 may be a central processing unit (CPU), a blade, an application specific integrated circuit (ASIC), a field-programmable gate array (FPGA), or another suitable component. Generally, the processor 108 executes instructions and manipulates data to perform the operations of the user device 102 and, specifically, the functionality associated with the user application 122, the image application 124, and the conversion engine 126.

The user application 122 can include any software, hardware, firmware, or combination thereof operable to access, retrieve, modify, delete, or otherwise manage some information of the original files 110 in memory 106. Specifically, the user application 122 may access the original files 110 to retrieve or modify data as requested by a user and/or another application. The user application 130 may be considered software or solution that is capable of interacting or integrating with the original files 110 located, for example, in memory 106 to provide access to data for personal or business use. An example user application 130 may be a computer application for performing any suitable process by implementing or executing a plurality of steps. One example of a user application 130 is an email application that receives email files 110 from the network 104 and presents emails to the user based on the email files 110. As a result, the user application 122 may provide a method of accessing emails and presenting it to the user and/or application such that the user and/or application are provided information through the GUI 128 in a centralized manner. In some implementations, the email application 122 can communicate with other users, applications, systems, and components to send, receive, and process email files and/or messages. In some instances, the application 122 may operate in response to and in connection with one or more emails received from a remote client. For example, the application 122 may be Microsoft Outlook, Pegasus Mail, Mozilla's Thunderbird, Apple Inc.'s Mail, or other appropriate email client. In some examples, the application 122 may be a web application or webmail such as Hotmail, Gmail, AOL, Yahoo, or others.

The image application 124 can include any software, hardware, firmware, or combination thereof operable to generate images based, at least in part, on the converted files 112. For example, the image application 124 may automatically generate an image substantially similar to the presentation of a corresponding original file 110 using a converted file 112. In general, the image application 124 may execute one or more of the following: identify one or more converted files 112 selected by the user; automatically populate an image with attributes defined by the presentation format 120; present the generated image to the user through the GUI 128; and/or others. As previously described, the image application 124 may present images and prevent users from modifying the converted files 112.

The conversion engine 126 can include any software, hardware, firmware, or combination thereof configured to convert the original files 110 to the converted files 112. For example, the conversion engine 126 may convert an email file 110 to a PDF file 112 in response to a user selection. In some implementations, the conversion engine 126 may execute one or more of the following: determine an original file 110 in first file format native to the user application 122 has been selected through the frontend 130; automatically generate a converted file 112 in a second file format native to the image application 124; store data from the original file 110 in the converted file 112; determine the original file 110 includes an attachment 116; embedded the attachment 116 in the converted file 112 as attachment 120; determine a converted file 112 has exceed a predefined time period; delete the converted file 112 that exceeds the predefined time period; determine an original file 110 currently selected has previously been previously converted to a converted file 112; prevent generate of a second converted file 112 for the previously-converted original file 116; delete the original file 110 in connection with generating a corresponding converted file 112; generate a title for the converted file 112 based on data stored in the original file 110; and/or others. In regards to selecting an original file 110, the conversion engine 126 may determine or otherwise identify that a user has selected an original file 110 using the frontend 130. For example, the conversion engine 126 may identify that the original file 110 was selected in the frontend 130 and moved to the virtual folder 134. In some implementations, the conversion engine 126 may determine that a plurality of original files 110 have been selected from the frontend 130 and moved to the virtual file 134. In some implementations, the conversion engine 126 may converted a file between different formats such as an email file compatible with the user application 122 and an image file 112 compatible with the image application 124. For example, the conversion engine 126 may generate a new file when generating the converted file 112 or modify the existing original file 110 into the converted file 112. In the email example, the original files 110 may be an MSG file compatible with Microsoft Outlook, and the converted file 112 may be an image file (e.g., PDF, JPEG, TIFF). In some implementations, the conversion engine 126 may generate the converted file 112 as a read-only file to substantially prevent future editing or tampering with the data from the original file 110. In connection with generating the converted file 112, the conversion engine 126 may store data such as metadata in the converted file 112. For example, the conversion engine 126 may store all data from the original file 110 in one or more converted files 112.

In some implementations, the conversion engine 126 can automatically generate a title based on data (e.g., metadata) stored in the original files 110. For example, the conversion engine 126 may generate a title including the date of an email was received, (e.g., YYYY-MM-DD), the time when the email was sent, the subject line, the sender's email, and/or other information. The conversion engine 126 may also set archiving policies when generating the converted files 112. For example, the conversion engine 126 may identify a period of time that the converted file 112 may be stored in memory 106, and upon expiration of the time period, the conversion engine 1126 or other executed process may automatically delete the converted file 112. In some implementations, the conversion engine 126 may automatically delete original files 110 that have been successfully converted to the converted file 112. The conversion engine 126 may maintain the integrity of the attachments, metadata, links, URLs, HTMLs, and/or other aspects. For example, the conversion engine 126 may embedded an attachment 116 in the original file in the converted file 120 in the original format. In the email examples, the conversion engine 126 may embed an excel attachment 120 in the image file 112 that was originally attached in an email file 110 as attachment 116. In doing this, the conversion engine 126 does not modify the file format of the original attachment 116. In some implementations, the conversion engine 126 may convert parties (e.g., To, From, CC, BCC, etc.) included in the original files 110 into links for initiating new emails. In some implementations, the conversion engine 126 may generate an index for the converted files 112 to facility searching. In some instances, the conversion engine 126 may include a search engine configured to search the generated index. The search engine may be executed by another part of the processor 108 without departing from the disclosure.

Further, while illustrated as internal to the user device 102, one or more processes associated with one of the user application 122, the image application 124, and/or the conversion engine 126 may be stored, referenced, or executed remotely. For example, a portion of the user application 122, the image application 124, and/or the conversion engine 126 may be a web service that is remotely called, while another portion of the user application 122, the image application 124, and/or the conversion engine 126 may be an interface object or agent bundled for processing at a remote system (not illustrated), or a particular external entity (e.g., a web-based application). Moreover, any or all of the user application 122, the image application 124, and/or the conversion engine 126 may be a child or sub-module of another software module or enterprise application (not illustrated) without departing from the scope of this disclosure. Still further, portions of the user application 122, the image application 124, and/or the conversion engine 126 may be executed or accessed by a user working directly at the user device 102, as well as indirectly at a remote terminal.

The network 104 may be all or a portion of an enterprise or secured network, while in another instance, at least a portion of the network 104 may represent a connection to the Internet. In the illustrated example, at least a portion of the network 104 includes a portion of a cellular or mobile data network or other network capable of relaying SMS messages. In some instances, a portion of the network 104 may be a virtual private network (VPN). Further, all or a portion of the network 104 can include either a wireline or wireless link. Example wireless links may include 802.11/b/g/n, 802.20, WiMax®, and/or any other appropriate wireless link. In other words, the network 104 encompasses any internal or external network, networks, sub-network, or combination thereof operable to facilitate communications between various computing components inside and outside the illustrated environment 100. The network 104 may communicate, for example, Internet Protocol (IP) packets, Frame Relay frames, Asynchronous Transfer Mode (ATM) cells, voice, video, data, and other suitable information between network addresses. The network 104 may also include one or more local area networks (LANs), radio access networks (RANs), metropolitan area networks (MANs), wide area networks (WANs), all or a portion of the Internet, and/or any other communication system or systems at one or more locations.

Regardless of the particular implementation, “application” or “software” may include computer-readable instructions, firmware, wired or programmed hardware, or any combination thereof on a tangible and non-transitory medium operable when executed to perform at least the processes and operations described herein. Indeed, each software component may be fully or partially written or described in any appropriate computer language including C, C++, Java®, Visual Basic, assembler, Perl®, any suitable version of 4GL, as well as others. It will be understood that while portions of the software illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components, as appropriate. In the illustrated environment 100, the processor 108 executes the user application 122, the image application 124, and the conversion engine 126 and the user application 122, the image application 124, and the conversion engine 126 are stored on the user device 102. In some instances, a particular user device 102 may be associated with the execution of two or more user applications 122, image applications 124, and/or conversion engines 126 (and other related components), as well as one or more distributed applications executing across two or more servers executing the functionality associated with the user device 102.

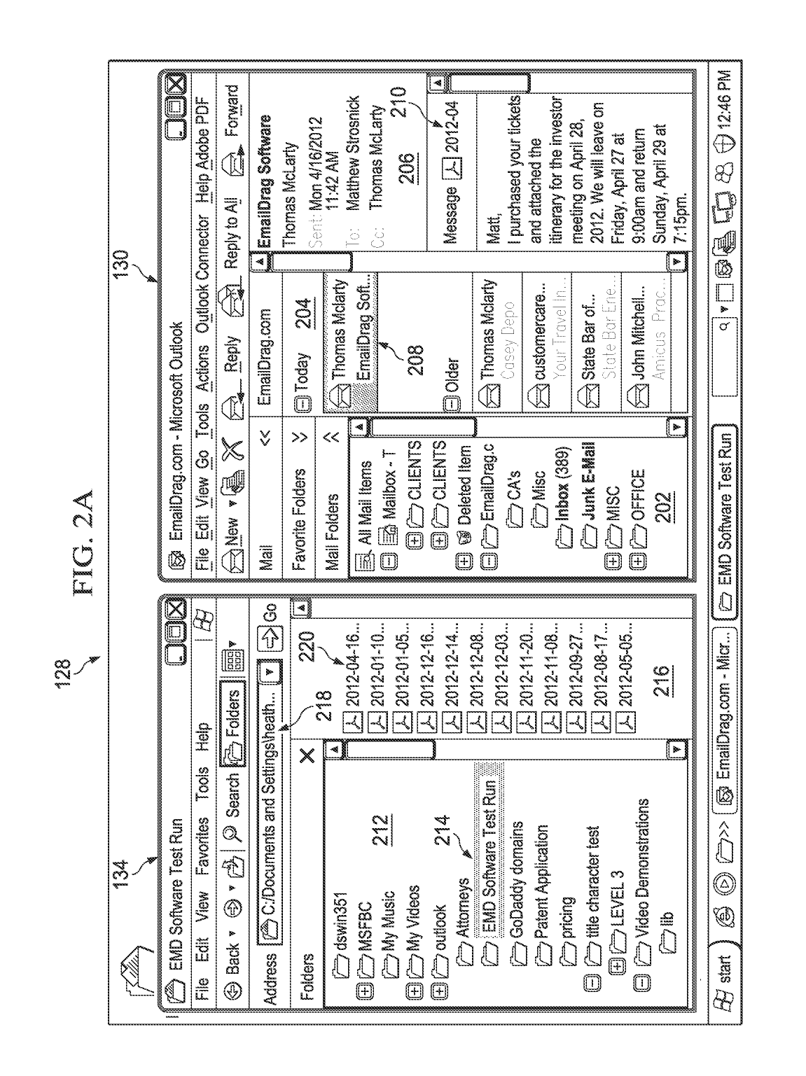

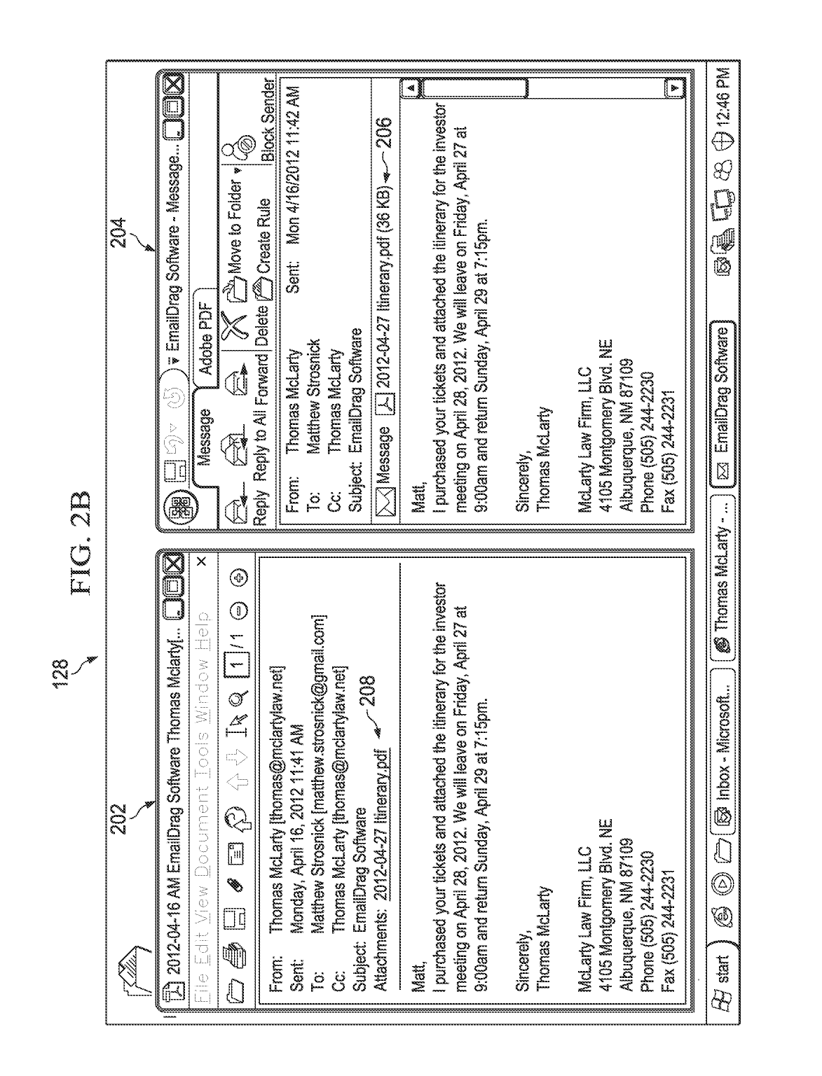

FIG. 2A is an example GUI 128 for converting email files to images files in accordance with some implementations of the present disclosure. The example GUI 128 includes a frontend 130 for an email application and a virtual folder 134. The email application can be, for example, Microsoft Outlook, Pegasus Mail, Mozilla's Thunderbird, Apple Inc.'s Mail, or other appropriate email client. The frontend 130 includes a file hierarchy 202 of the different mail folders with expandable nodes to navigate to subfolders. For the email folder selected in the hierarchy 202, the frontend 130 displays an inbox 204 listing the titles of email files in the selected folder. The frontend 130 also includes a window 206 that presents the email 208 selected in the inbox 204. In the illustrated implementation, the presented email 208 includes an attachment 210. The email files listed may be selected individually or in groups to be moved to the virtual folder 134.

In the illustrated implementation, the virtual folder 134 includes a file hierarchy 212 with nodes that expand and collapse. Each node represents a folder that stores other folders or files. In response to a user selecting a folder 214 in the file hierarchy 212, the virtual folder 134 presents a window 216 listing files stored in the folder 134. The virtual folder 134 also includes an address bar 218 indicating a current file address of the selected folder 214. In connection with converting the email 208, the conversion engine 126 generates the file 220 illustrated in the window 216. In this example, the conversion engine generated a PDF file 220 having a title based on the date, time, subject, and sender's email address.

FIG. 2B is another example GUI 128 illustrates a display 202 of a converted file 112 next to a display 204 of an original email file 110. The converted file 112 is in a format native to the image application 124 has a presentation format substantially similar to The display 202 illustrates that the converted file 220 includes a presentation format substantially similar to the presentation format of the display 204 of the email file 208. For example, the display 202 and 204 include formats, font sizes and types, letter arrangements, and other attributes that are substantially similar. In addition, the attachment 206 in the display 204 is included as the attachment 208 in the display 202. In some implementations, the format of the attachment 206 and the attachment 208 are the same.

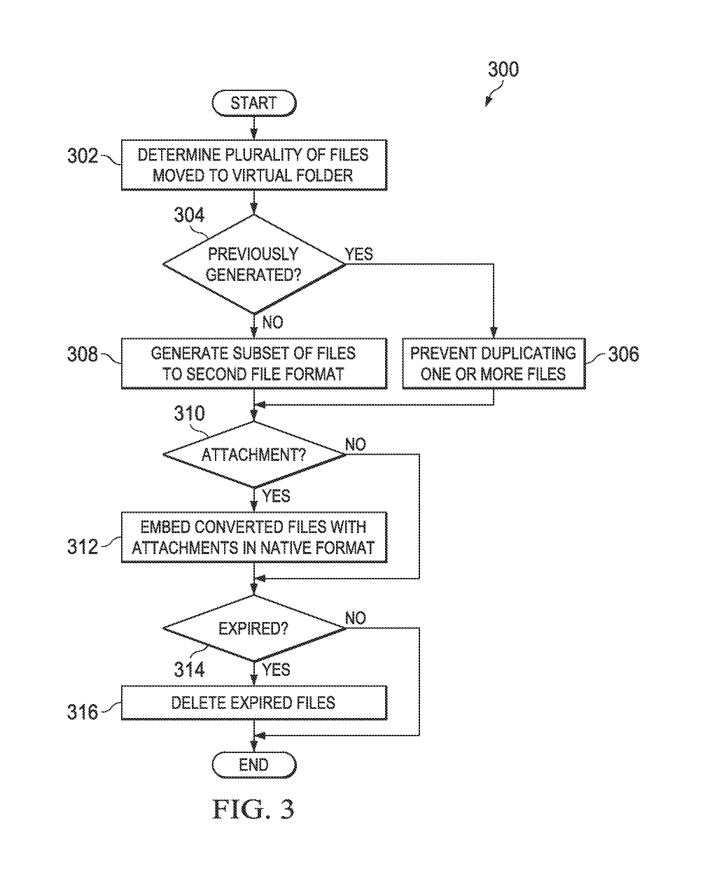

FIG. 3 is a flow chart 300 of an example method for automatically converting emails into image files. In particular, method 300 describes automatically converting an email file to an image file in response to a user moving the email file to a virtual folder. These methods are for illustration purposes only and that the described or similar techniques may be performed at any appropriate time, including concurrently, individually, or in combination. In addition, many of the steps in these flowcharts may take place simultaneously and/or in different orders than as shown. Moreover, systems may use methods with additional steps, fewer steps, and/or different steps, so long as the methods remain appropriate.

Method 300 begins at step 302 where a plurality of files is moved to a virtual folder in a GUI. For example, a plurality of the original files 110 in FIG. 1 may be selected through the frontend 130 and moved to the virtual folder 134. If a file was previously converted to a file in a second format at decisional step 304, then, at step 306, the conversion of the previously-converted files is prevented. In the example, the conversion engine 126 may determine that a subset of original files 110 were previously converted to converted files 112 and prevent duplicating the conversion. If the selected files were not previously converted, then files are generated in a second file format that corresponds to a subset of files in the first subset at step 308. Again in the example, the conversion engine 126 may generate converted files 112 for the subset of original files 110 that were not previously converted. If the selected files include attachments at decisional step 310, then, at step 312, the converted files are embedded with the attachments in a format. Returning to the example, the conversion engine 126 may embed the attachments 120 with the same format as the attachments 116 embedded in the original files. If no attachments are included, execution proceeds to decisional step 314. If a predefined time period expires for a converted file at decisional step 314, then, at step 316, the expired file is deleted. Returning to the example, the conversion engine 126 may determine whether a time period for archiving a converted file has expired and, if so, delete expired converted files 112.

A number of embodiments of the invention have been described. Nevertheless, it will be understood that various modifications may be made without departing from the spirit and scope of the invention. For example, an email application can be a web-based application executed in a web browser. The emails retrieved in the web application may be selected and moved into the virtual folder for conversion and archival in a similar manner as disclosed. Accordingly, other embodiments are within the scope of the following claims.

1. A method for archiving emails, comprising:
presenting, using an archiving application, email folders for an email application, wherein each folders including email files presentable using the email application;
selecting an email folder presented using the archiving application, wherein each email file in the selected email folder is in a first file format native to the email application and has a first presentation format when presented using the email application;
for each email file in the selected email folder, generating a second file in a second file format native to a second application different from the email application, wherein the second file has, when presented using the second application the first presentation format;
for each email file, determining metadata for that email file in the first file format and whether that email file includes an attachment native to a third application; and
for each email file including an attachment, embedding the attachment from that email file directly into the corresponding second file, wherein the embedded attachment is maintained in a format native to the third application; and
for the metadata contained in each email file, embedding the metadata from that email file directly into the corresponding second file.

2. The method of claim 1, wherein the file was moved into the virtual folder in a file folder including a plurality of files including the email file.

3. The method of claim 1, wherein the second file comprises a Portable Document Format (PDF) file, a Word file, or an image file.

4. (canceled)

5. The method of claim 1, wherein the third application is different from the email application and the second application.

6. The method of claim 1, further comprising generating a title for the second file based on the data of the email file in the first file format.

7. The method of claim 6, wherein the title includes at least one of a date, a time, a time sent, a time created, a subject line, a recipient's email address or a sender's email address.

8. The method of claim 1, further comprising:
determining a plurality of files in the virtual folder have exceed a predefined time period; and
automatically deleting the plurality of files.

9. The method of claim 1, further comprising:
determining a plurality of email files, including the email file, in the first file format have been moved into the virtual folder;
determining one of the plurality of email files was previously generated into a file in the second file format;
preventing generation of a file in the second file format for the one of the plurality of emails files to form a subset of email files; and
for each of the subset of email files, generating a file in the second file format, wherein each file includes a presentation format substantially similar to a presentation format of a corresponding one of the subset of files.

10. The method of claim 1, further comprising deleting the email file from the email application in connection with generating the second file.

11. The method of claim 1, wherein all data in the email file is stored in the second file.

12. A computer program product encoded on a tangible, non-transitory storage medium, the product comprising computer readable instructions for causing one or more processors to perform operations comprising:
presenting, using an archiving application, email folders for an email application, wherein each folders including email files presentable using the email application;
selecting an email folder presented using the archiving application, wherein each email file in the selected email folder is in a first file format native to the email application and has a first presentation format when presented using the email application;
for each email file in the selected email folder, generating a second file in a second file format native to a second application different from the email application, wherein the second file has, when presented using the second application the first presentation format;
for each email file, determining metadata for that email file in the first file format and whether that email file includes an attachment native to a third application; and
for each email file including an attachment, embedding the attachment from that email file directly into the corresponding second file, wherein the embedded attachment is maintained in a format native to the third application; and
for the metadata contained in each email file, embedding the metadata from that email file directly into the corresponding second file.

13. The computer program product of claim 12, wherein the file was moved into the virtual folder in a file folder including a plurality of files including the email file.

14. The computer program product of claim 12, wherein the second file comprises a Portable Document Format (PDF) file, a Word file, or an image file.

15. (canceled)

16. The computer program product of claim 12, wherein the third application is different from the email application and the second application.

17. The computer program product of claim 12, the instructions further comprising generating a title for the second file based on the data of the email file in the first file format.

18. The computer program product of claim 17, wherein the title includes at least one of a date, a time, a time sent, a time created, a subject line, a recipient's email address or a sender's email address.

19. The computer program product of claim 12, the instructions further comprising:
determining a plurality of files in the virtual folder have exceed a predefined time period; and
automatically deleting the plurality of files.

20. The computer program product of claim 12, the instructions further comprising:
determining a plurality of email files, including the email file, in the first file format have been moved into the virtual folder;
determining one of the plurality of email files was previously generated into a file in the second file format;
preventing generation of a file in the second file format for the one of the plurality of emails files to form a subset of email files; and
for each of the subset of email files, generating a file in the second file format, wherein each file includes a presentation format substantially similar to a presentation format of a corresponding one of the subset of files.

21. The computer program product of claim 12, the instructions further comprising deleting the email file from the email application in connection with generating the second file.

22. The computer program product of claim 12, wherein all data in the email file is stored in the second file.
